(19) United States
(12) Patent Application Publication
(10) Pub. No.: US 2026/0200061 A1
(43) Pub. Date: Jul. 16, 2026

(54) Flat chisel

(71) Applicant: Hilti Aktiengesellschaft, Schaan (LI)

(72) Inventors: Gabor RAKONCZAI, Fülöpháza (HU); József SZABÓ, Schönburg (DE); Bálint HORVÁTH, Kecskemét (HU)

(21) Appl. No.: 19/134,374

(22) PCT Filed: Nov. 30, 2023
(86) PCT No.: PCT/EP2023/083705

§ 371 Date: May 30, 2025

(30) Foreign Application Priority Data
Dec. 7, 2022 (EP) 22212035.4

(51) Int. Cl. B25D 17/02

(52) U.S. Cl. CPC B25D 17/02; B25D 2222/72

(57) ABSTRACT

A chisel (10) which includes a working section (12), a shaft section (14), a shank (24), and a longitudinal axis (L) running through the working section (12), the shaft section (14) and the shank (24), wherein there are formed on the working section (12) at least one wedge-shaped cutting edge (18) and a rib (22) running parallel or at least substantially parallel to the longitudinal axis (L) and facing radially away from the longitudinal axis (L). The rib (22) is locally thickened in at least one rib region (36). The chisel (10) makes it possible to work with particularly few interruptions and thus efficiently.

The invention relates to a chisel which comprises a working section, a shaft section, a shank, and a longitudinal axis running through the working section.

### BACKGROUND

Such chisels are used on construction sites to chisel mineral stone, for example concrete.

### SUMMARY OF THE INVENTION

However, during chiseling at a work site, it can happen that such a chisel sticks in the stone, which can result in stoppages, lost time and thus high costs. It may also become necessary to interrupt chiseling in order to free the work site of chiseling dust if the chiseling dust increasingly remains at the work site, in particular in a chiseled depression, or accumulates there.

It is an object of the present invention to provide a chisel which allows work to be carried out if possible without interruption or at least with particularly few interruptions.

The present invention provides a chisel which comprises a working section, a shaft section, a shank, and a longitudinal axis running through the working section, the shaft section and the shank, wherein there are formed on the working section at least one wedge-shaped cutting edge and a rib running parallel or at least substantially parallel to the longitudinal axis and facing radially away from the longitudinal axis, wherein the rib is locally thickened in at least one rib region.

The rib thus has a local thickening in the rib region. The local thickening can in particular be in a foot region of the rib. The foot region can correspond to a region of the rib that faces toward the inside of the chisel, in particular toward the longitudinal axis.

An inscribed ellipse of a cross section of the rib region can have a larger surface area than an inscribed ellipse of a cross section of a region of the chisel directly adjoining the rib region.

In the case, for example, of a non-rotationally symmetrical chisel, such as a channel chisel, a longitudinal plane of the chisel may also be regarded as the longitudinal axis.

Tests have shown that, for example when chiseling in depressions, such a local thickening can create a free space between the chisel and a wall of the depression. The chisel can thus remain movable even in the case of prolonged chiseling in the depression and even at considerable depths within the depression. The chisel can thus be prevented from sticking, or at least the risk of its sticking can be reduced considerably, so that fewer stoppages or no stoppages at all are required in order to free a stuck chisel from the depression.

It has further been observed that the local thickening improves the removal of chiseling dust. In particular, chiseling dust produced during chiseling is able, by its own movement, to reach at least a region of the chisel above, that is to say in the direction toward the shank, the local thickening. By means of continued forward and backward movements of the chisel along its longitudinal axis, the chiseling dust can additionally be accelerated, in particular during a backward movement, so that it can be thrown outside even from comparatively deep depressions. As a result of the improved removal too, stoppages can be avoided, or at least the frequency thereof can be reduced.

The chisel can be in the form of a flat chisel. To this end, the chisel can have a cutting edge with a non-vanishing, that is to say finite, cutting edge width. The cutting edge width can be, for example, at least 0.5 cm. The cutting edge can be in the form of a prism. The working section can taper along at least one dimension at least toward the cutting edge.

It is conceivable that the working section tapers toward the cutting edge in at least two mutually perpendicular dimensions. The chisel, in particular in conjunction with its wedge-shaped cutting edge, can thus combine the advantages of flat chisels and pointed chisels.

The ribs can extend in a plurality of dimensions. In particular, there can be formed on the working section four ribs in particular running parallel or at least substantially parallel to the longitudinal axis and facing radially away from the longitudinal axis.

At least one of the ribs, a plurality of the ribs, in particular all the ribs, can be locally thickened.

At least two, in particular two, of the ribs can extend in the form of lateral ribs along a plane including the longitudinal axis.

At least two, in particular two, of the ribs can extend in the form of vertical ribs perpendicular or at least substantially perpendicular to the plane.

Thus, the at least two lateral ribs and the at least two vertical ribs can have a cross-shaped cross section overall.

In order to further improve the function of the chisel as a flat chisel, at least one of the vertical ribs can have a smaller height than at least one of the lateral ribs. The height of a rib can be understood as meaning the greatest of all the distances of all the points of a rib from the longitudinal axis. Apart from the height and the orientation, the vertical ribs and the lateral ribs can be formed identically on the chisel.

The lateral ribs can direct fracturing in the worked substrate during chiseling. The vertical ribs can generate additional stresses in the substrate and thus additionally accelerate fracturing.

Such a local thickening can be formed in the case of at least one of the lateral ribs. It is also or alternatively conceivable that such a local thickening is formed in the case of at least one of the vertical ribs.

The chisel can be produced without machining, in particular by plastic shaping, and/or by machining.

Further features and advantages of the invention are apparent from the following detailed description of exemplary embodiments of the invention, with reference to the figures of the drawing which shows details essential to the invention, and from the claims. The features shown therein should not necessarily be considered to be true to scale and are illustrated in such a manner that the special features according to the invention can be clearly visualized. The various features can be implemented individually in their own right or collectively in any combinations in variants of the invention.

### BRIEF DESCRIPTION OF THE DRAWINGS

Exemplary embodiments of the invention are illustrated in the schematic drawing and explained in detail in the following description.

### In the FIGURES:

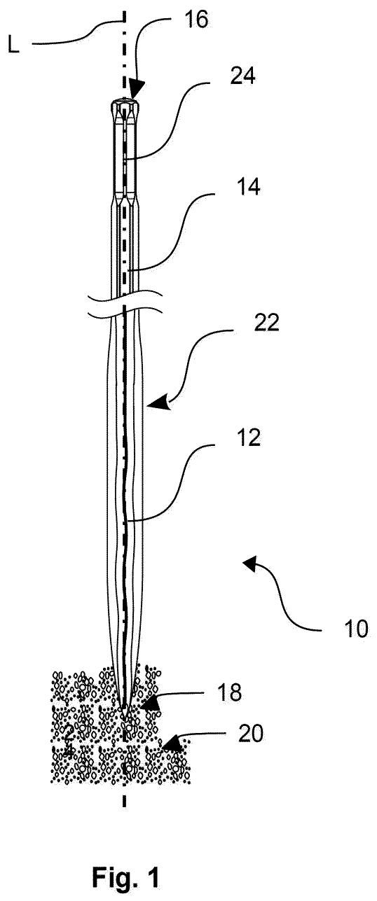

FIG. 1 shows a chisel,

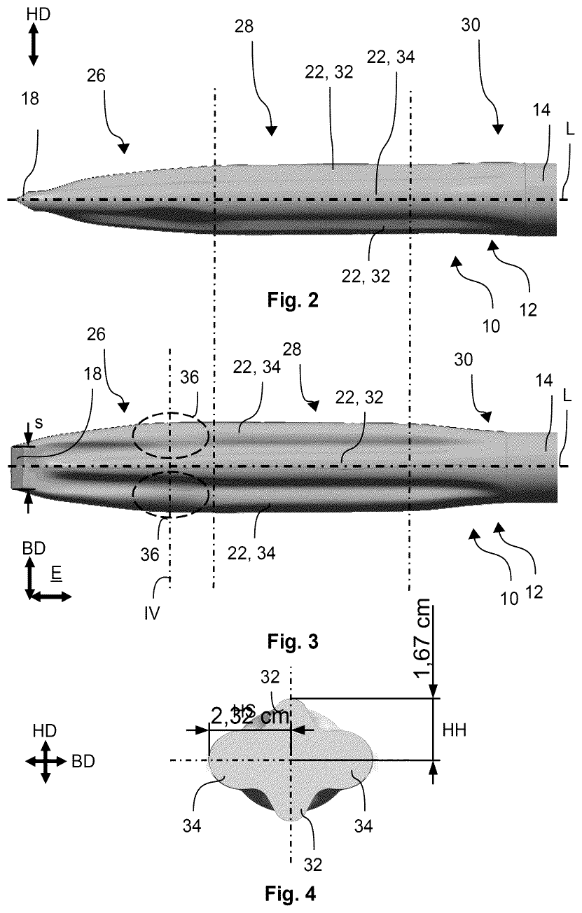

FIG. 2 shows a side view of a working section of the chisel,

FIG. 3 shows a rotated side view of the working section of the chisel,

FIG. 4 shows a cross section of the chisel,

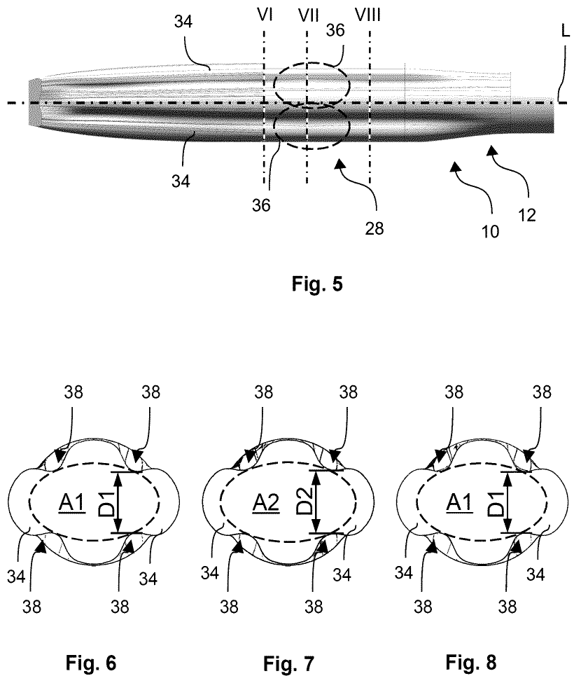

FIG. 5 shows a working section of a further chisel, and

FIGS. 6 to 8 show cross sections of the chisel according to FIG. 5.

### DETAILED DESCRIPTION

In the description of the figures that follows, comprehension of the invention is facilitated by use of the same reference signs in each case for identical or functionally corresponding elements.

FIG. 1 shows a chisel 10 in a side view. The chisel 10 is in the form of a flat chisel. It has a working section 12, a shaft section 14 and a striking surface 16. At the free end of its working section 12, the chisel 10 has a cutting edge 18.

A longitudinal axis L runs through the working section 12, the shaft section 14 and the striking surface 16.

The chisel 10 can be driven into a substrate 20 by blows on its striking surface 16, for example with the aid of a machine tool mounted in the region of the striking surface 16. In the example according to FIG. 1, the substrate 20 is a mineral substrate, e.g. reinforced concrete.

In the exemplary embodiment of the chisel 10 shown in FIG. 1, the working section 12 has a plurality of ribs 22. To simplify the illustration, only one of the ribs 22 is provided with a reference sign in FIG. 1.

Over the life of the chisel 10, the working section 12 usually wears down, whereas the shaft section 14 does not or does so at most to an insignificant extent.

A shank 24 is formed on the shaft section 14. In the exemplary embodiment shown in FIG. 1, the shank 24 can be designed as a hexagon and/or comprises such a hexagon. Alternatively, it is also conceivable that the shank 24 corresponds to some other standard, for example a standard usually referred to as “SDS Plus” or “SDS Max”.

FIG. 2 shows the working section 12 of the chisel 10 in a side view, and FIG. 3 shows it in a rotated side view.

The working section 12 has a tip zone 26, a middle zone 28 and a transition zone 30.

In the tip zone 26, the cross section of the chisel 10 decreases along the longitudinal axis L to the cutting edge 18.

The cutting edge itself is in the form of a prism and thus has a non-vanishing, that is to say finite, cutting edge width s, for example in the range of from 0.5 to 5 cm.

A total of four ribs 22 are formed on the working section 12. Two ribs 22 extend in the form of vertical ribs 32 along the height dimension HD (see FIG. 2). Two ribs 22 extend in the form of lateral ribs 34 along the width dimension BD (see FIG. 3). They thus extend along a plane E including the longitudinal axis L. In the illustration according to FIG. 3, the plane E runs parallel to the image plane of FIG. 3.

The vertical ribs 32 thus extend perpendicular to the plane E.

In this exemplary embodiment, the vertical ribs 32 on the one hand and the lateral ribs 34 on the other hand are each formed in pairs as a mirror image of one another.

In the middle zone 28, the width of the chisel 10 is constant or at least substantially constant, in particular apart from locally limited changes in the ribs 22.

In the transition zone 30, the cross section is adapted steplessly to the adjoining shaft section 14.

As can be seen in particular with reference to FIG. 3, the lateral ribs 34 are locally thickened in rib regions 36. In this exemplary embodiment, the rib regions 36 are located in the tip zone 26.

FIG. 4 shows a cross section through the working section 12 of the chisel 10 according to section line IV from FIG. 3. It can be seen that the vertical ribs 32 have a smaller height HH, in particular measured along the height dimension HD, than the lateral ribs 34, which have a height HS, measured along the width dimension BD.

FIG. 5 shows a working section 12 of a further chisel in a side view. This exemplary embodiment too has lateral ribs 34 which are thickened within rib regions 36. However, in this exemplary embodiment the rib regions 36 are located in the middle zone 28. The rib regions 36 are thus located in a section of the chisel 10 in which its total width is constant or at least substantially constant.

FIG. 6 to FIG. 8 show cross-sectional views of the chisel 10 according to the exemplary embodiment corresponding to FIG. 5 according to section lines VI, VII and Vill from FIG. 5.

In foot regions 38, the lateral ribs 34 have the same thicknesses D1 along section lines VI and VIII, as can be seen in FIG. 6 and FIG. 8.

In foot regions 38, the lateral ribs 34 have thickness D2 along section line VII, as can be seen in FIG. 7.

Thickness D2 along section line VII (see FIG. 7) is thicker than thickness D1 along section lines VI and VIII (see FIG. 6 and FIG. 8).

An ellipse inscribed into the cross section according to FIG. 7 has a cross-sectional area A2. Ellipses inscribed into the cross sections according to FIG. 6 and FIG. 8 each have a cross-sectional area A1. Cross-sectional area A2 is greater than cross-sectional area A1.

A minimum distance between the section lines VI and VIII, that is to say a minimum distance within which the thickness of the ribs in question, here of the lateral ribs 34, is locally thickened, can be not more than 5 cm.

### LIST OF REFERENCE SIGNS

10 Chisel
12 Working section
14 Shaft section
16 Striking surface
18 Cutting edge
20 Substrate
22 Rib
24 Shank
26 Tip zone
28 Middle zone
30 Transition zone
32 Vertical rib
34 Lateral rib
36 Rib region
38 Foot region
A1 Cross-sectional area
A2 Cross-sectional area
BD Width dimension
D1 Thickness
D2 Thickness
E Plane
HD Height dimension
HH Height
HS Height
IV Section line
VI Section line
VII Section line
VIII Section line
L Longitudinal axis
s Cutting edge width

What is claimed is:

1-7. (canceled)

8. A chisel comprising:
a working section;
a shaft section;
a shank, a longitudinal axis running through the working section, the shaft section and the shank; and
at least one wedge-shaped cutting edge and at least one rib formed on the working section and running parallel to the longitudinal axis and facing radially away from the longitudinal axis,
the at least one rib being locally thickened in at least one rib region.

9. The chisel as recited in claim 8 wherein the chisel is in the form of a flat chisel.

10. The chisel as recited in claim 8 wherein the working section tapers toward a cutting edge in two mutually perpendicular directions.

11. The chisel as recited in claim 8 wherein the at least one rib includes four ribs.

12. The chisel as recited in claim 8 wherein the at least one rib has two ribs extending in the form of lateral ribs along a plane including the longitudinal axis.

13. The chisel as recited in claim 12 wherein the at least one rib has two further ribs extending in the form of vertical ribs perpendicular to the plane.

14. The chisel as recited in claim 13 wherein at least one of the vertical ribs has a smaller height than at least one of the lateral ribs.
